(19) United States
(12) Patent Application Publication
(10) Pub. No.: US 2014/0172361 A1
(43) Pub. Date: Jun. 19, 2014

(54) MULTI-POSTURE STRIDE LENGTH CALIBRATION SYSTEM AND METHOD FOR INDOOR POSITIONING

(71) Applicant: Industrial Technology Research Institute, Hsinchu (TW)

(72) Inventors: Jen-Chieh Chiang, Kaohsiung City (TW); Kun-Chi Feng, New Taipei City (TW); Xu-Peng He, Hsinchu County (TW); Lun-Chia Kuo, Taichung City (TW)

(21) Appl. No.: 13/924,738

(22) Filed: Jun. 24, 2013

(30) Foreign Application Priority Data
Dec. 19, 2012 (TW) 101148475

(51) Int. Cl. G01C 22/00

(52) U.S. Cl. CPC G01C 22/006
USPC 702/160

(57) ABSTRACT

A multi-posture stride length calibration system for indoor positioning includes: at least an inertial measurement unit, configured to sense at least a signal; a signal preprocessing unit, connected to the inertial measurement unit to process sensed signal; a multi-posture determination unit, configured to determine at least a posture based on processed signal; a step-computing decision unit, configured to compute a number of steps and a step frequency based on processed signal; a map feature calibration unit, configured to receive the number of steps, step frequency and posture to determined a stride length and decide whether the stride length matching a criterion; a step-computing threshold adjustment unit, configured to adjust a step-computing threshold if stride length not matching the criterion; and a stride length regression unit, configured to update a stride length regression curve for posture based on step frequency and stride length if stride length matching the criterion.

### CROSS-REFERENCE TO RELATED APPLICATION

The present application is based on, and claims priority form, Taiwan Patent Application No. 101148475, filed Dec. 19, 2012, the disclosure of which is hereby incorporated by reference herein in its entirety.

### TECHNICAL FIELD

The technical field generally relates to a multi-posture stride length calibration system and method for indoor positioning.

### BACKGROUND

The recent mobile devices are equipped with various types of sensing elements. As the mobile positioning technique also undergoes rapid growth in recent years, positioning information services, such as, personal navigation, social network sharing and location-based service (LBS) are becoming the new focus of the mobile devices. However, to obtain real-time and accurate indoor positioning and navigation services depends on the capability of the smart mobile devices with the equipped sensing elements to perform key functions.

The conventional inertial measurement unit (IMU) positioning system relies on the motion sensors, such as, accelerometer, gyroscope, magnetometer, and so on, to estimate the direction and the distance of the movement. However, when using smart mobile device for positioning, a user may hold or place the mobile device in various postures, which will affect the signals measured by the IMUs. In addition, because inertial navigation is based on the displacement and the direction of the movement to compute, the accumulated error will increase as the distance increases. Errors also exist among different users.

### SUMMARY

An exemplary embodiment describes a multi-posture stride length calibration system for indoor positioning, applicable to a mobile device. The multi-posture stride length calibration system includes: at least an inertial measurement unit, configured to sense at least a signal of the mobile device; a signal preprocessing unit, connected to the inertial measurement unit to process the sensed at least a signal; a multi-posture determination unit, configured to determine at least a posture based on the processed at least a signal; a step-computing decision unit, configured to compute a number of steps and a step frequency based on the processed at least a signal; a map feature calibration unit, configured to receive the number of steps, step frequency and posture to determined a stride length and decide whether the stride length matching a criterion; a step-computing threshold adjustment unit, configured to adjust a step-computing threshold if the stride length not matching the criterion; and a stride length regression unit, configured to update a stride length regression curve for posture based on step frequency and stride length if the stride length matching the criterion.

Another embodiment describes a multi-posture stride length calibration method for indoor positioning, applicable to a mobile device. The multi-posture stride length calibration method includes the following steps: based on at least a sensed signal, preprocessing the at least a sensed signal; based on the processed at least a signal, performing a posture judgment to determine a posture of the mobile device; based on the processed at least a signal, performing a step computation to compute a number of steps and a step frequency; based on the number of steps, step frequency and posture, computing a stride length and determining whether the stride length matching a criterion; when the stride length matching the criterion, updating a stride length regression curve for posture based on step frequency and stride length; and when the stride length not matching the criterion, adjusting a step-computing threshold and reperforming step computation.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of the structure of a multi-posture stride length calibration system for indoor positioning according to an exemplary embodiment;

FIG. 2 shows a flowchart of a multi-posture stride length calibration method for indoor positioning according to the present disclosure;

FIG. 3 shows a flowchart of the posture determination method of the multi-posture determination unit according to the present disclosure;

FIG. 4 shows a flowchart of a step-computing embodiment of the step-computing decision unit according to the present disclosure;

FIGS. 5A-5C show an exemplar of adjusting step-computing threshold;

FIG. 6 shows a flowchart of the real-time dynamic stride length calibration method of the present disclosure;

FIG. 7 shows a flowchart of using map feature and turning signal sensed by inertial measurement unit in indoor positioning according to the present disclosure;

FIG. 8 shows an exemplar of using map feature and turning signal to calibrate indoor positioning in FIG. 7;

FIG. 9 shows a flowchart of using map feature and multi-path tracking to calibrate indoor positioning according to the present disclosure; and

FIG. 10 shows an exemplary of using map feature and multi-path tracking to calibrate indoor positioning in FIG. 9.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

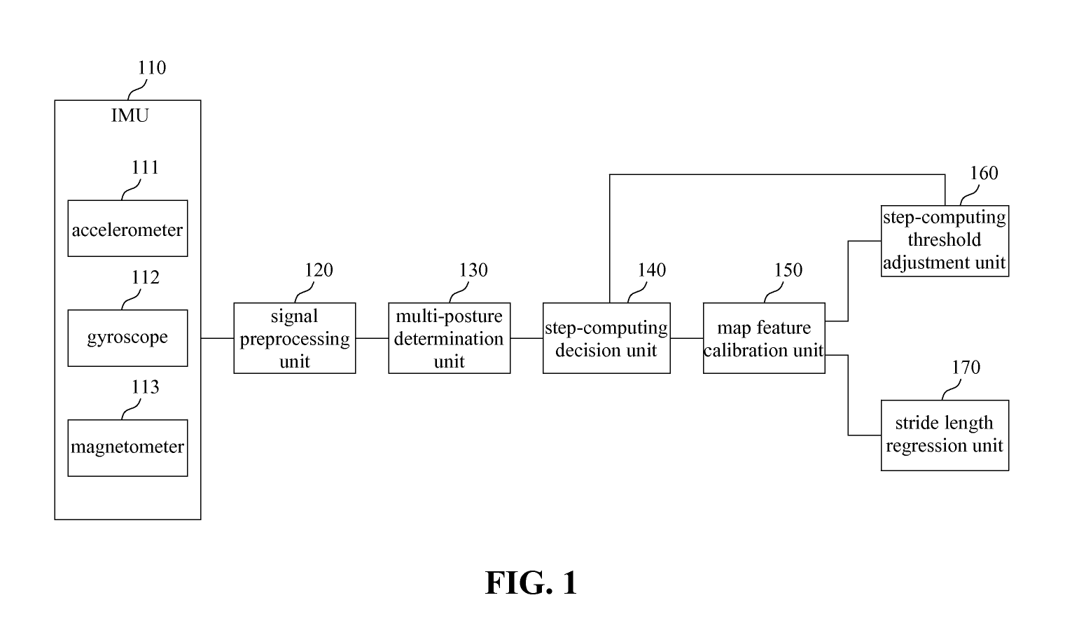

FIG. 1 shows a schematic view of the structure of a multi-posture stride length calibration system for indoor positioning according to an exemplary embodiment. 1, the multi-posture stride length calibration system for indoor positioning of the present embodiment is applicable to a mobile device, such as, smart phone, tablet PC, e-Book, PDA and tag, and can also be used in combination with a serving device. The multi-posture stride length calibration system for indoor positioning includes at least an inertial measurement unit 110 a signal preprocessing unit 120, a multi-posture determination unit 130, a step-computing decision unit 140, a map feature calibration unit 150, a step-computing threshold adjustment unit 160 and a stride length regression unit 170. In the present embodiment, the inertial measurement unit 110, such as, an accelerometer 111, a gyroscope 112 or a magnetometer 113, is configured to sense the posture of the user holding or placing the mobile device and the motion signal of the user; in other words, the inertial signals transmitted by the mobile signal at any time; the signal preprocessing unit 120 is connected to the inertial measurement unit 110 to process the at least a signal sensed by the inertial measurement unit 110; the multi-posture determination unit 130 is configured to determine at least a posture of the user holding or placing the mobile device based on the at least a signal processed by the signal preprocessing unit 120; the step-computing decision unit 140 is configured to compute a number of steps and a step frequency based on the at least a signal processed by the signal preprocessing unit 120 and transmit the number of steps, step frequency and the posture information to the map feature calibration unit 150; the map feature calibration unit 150 is configured to receive the number of steps, step frequency and posture to determined a stride length and decide whether the stride length is within a reasonable range for the stride length of the user; when the map feature calibration unit 150 determines that the stride length is not reasonable (i.e., outside of the reasonable range of the stride length), the step-computing threshold adjustment unit 160 adjusts a step-computing threshold; when the map feature calibration unit 150 determines that the stride length is reasonable, the stride length regression unit updates a stride length regression curve for the posture based on step frequency and stride length. When the mobile device of the present disclosure is used in combination with a serving device (not shown), the aforementioned map feature calibration unit 150, the step-computing threshold adjustment unit 160 and the stride length regression unit 170 can also be embodied in the serving device. Alternatively, all the elements and units, except the inertial measurement unit 110, can be embodied in the serving device. In addition, for communication between the serving device and the mobile device, both devices are disposed with a signal receiving and transmitting unit (not shown). The signal receiving and transmitting unit can be embodied either in wired or wireless manner.

In the present embodiment, the signal processing on the received signal by the signal preprocessing unit 120 includes any combination of signal calibration, synchronization, and filtering (such as, moving average filter and first-order infinite impulse response filter), as well as coordinate transformation (such as, Euler angles and quaternion), so as to convert the signals sensed by the inertial measurement unit 110 from the body coordinates of the user to the earth coordinates for subsequent processing. The multi-posture determination unit 130 then determines the posture of the user holding or placing the mobile device. The postures may include, for example, holding the mobile device in front of the chest when walking, holding the mobile device in hand and swinging the hand naturally when walking, hanging the mobile device at waist when walking, placing the mobile device in chest pocket or in pants pocket when walking, placing the mobile device in the handbag or backpack when walking, fastening the mobile device on shoe when walking, fastening the mobile device on torso or limbs when walking, and so on. Each of any combination of the above postures will generate a different acceleration pattern. Therefore, the multi-posture determination unit 130 must perform estimation on the motion pattern to switch among different step computation modes and compute.

The multi-posture determination unit 130 is able to determine the posture of the user holding or placing the mobile device based on the signals sensed by the magnetometer. For example, when the mobile device is placed horizontally inside the handbag, a set of three-axis magnetometer readings m can be measured, with the magnitude |m|. Take arc-tangent (atan) of mx and my (the readings along the x-axis and the y-axis respectively) to obtain the horizontal navigation angle a1. The tilt angle of Taiwan versus magnetic north pole is known to be a2. A rotation matrix T for coordinate transformation can be obtained by a1 and a2, and T*m=[0, |m|, 0]. When the mobile device is vertically placed inside the chest pocket, the above condition will not be met. In other words, the readings of the magnetometer can be used to determine whether the mobile device is placed inside a handbag or in a chest pocket of the user.

The multi-posture determination unit 130 is also able to use the readings on the accelerometer, gyroscope or magnetometer, or one of the above to compute the roll, pitch, or yaw of the posture of the user holding or placing the mobile device. For example, by analysis of the data collected for actual walking, there is a distinct difference in roll and pitch pattern for different posture of the user holding or placing the mobile device. If the user holds the mobile device in front of the chest when walking, a relatively stable pattern will appear because the user will watch the screen of the mobile device to monitor the positioning, which results in a smaller change in the magnitude of the roll. On the other hand, if the user holds the mobile device in hand and swings the hand naturally when walking, or hangs the mobile device around the waist when walking, the roll pattern shows a change close to 90° (or −90°). In addition, when holding the mobile device in hand and swinging the hand naturally when walking, the user also swings the mobile device along an arc trajectory, which results in a pitch pattern between 20° and −20°. Hence, by observing the change in acceleration of roll and pitch, the posture of the user holding or placing the mobile device can be identified.

When the user changes to a different posture of holding or placing the mobile device, the roll, pitch and yaw pattern will become stable and periodic after a transient duration of time, and is also distinct from the previous pattern. The multi-posture determination unit 130 is configured to automatically add the new identified posture for subsequent determination.

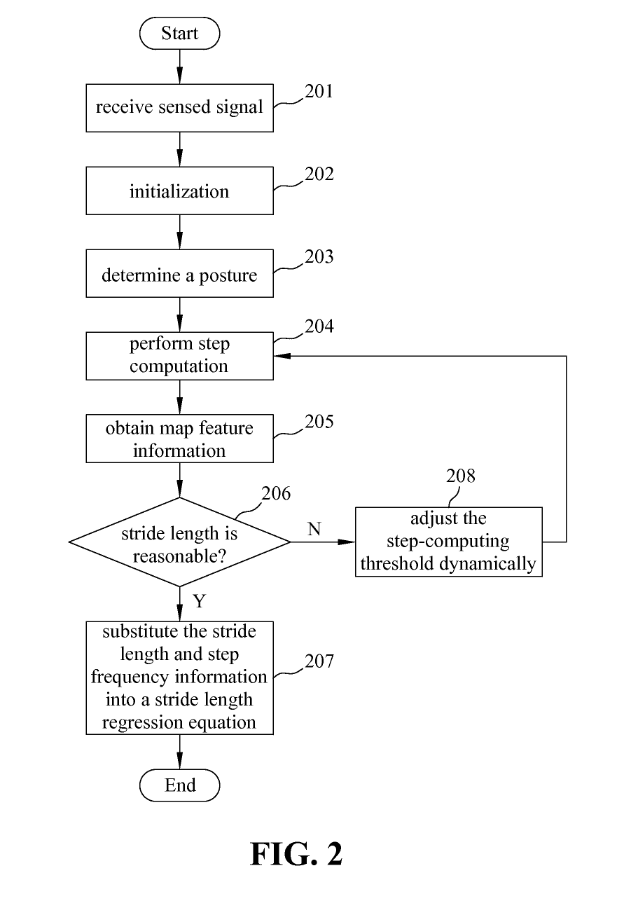

FIG. 2 shows a flowchart of a multi-posture stride length calibration method for indoor positioning according to the present disclosure. As shown in FIG. 2, step 201 is to receive at least a sensed signal and performing preprocessing on the sensed signal. The sensed signal can be, such as, the three-axis accelerometer readings, the angular acceleration reading of the gyroscope, the reading change of the magnetometer versus the earth magnetic field, the roll, pitch and yaw of the gyroscope and magnetometer, the amplitude of the acceleration along z-axis (perpendicular to the horizontal surface in the earth coordinate system), and so on. The above sensed signal is only for illustrative purpose, instead of restrictive. In addition, the embodiment in the present disclosure can operate with a single inertial measurement unit. The processing on the sensed signal can include, but not restricted to, any combination of signal calibration, synchronization, and filtering (such as, moving average filter and first-order infinite impulse response filter), as well as coordinate transformation (such as, Euler angles and quaternion). Step 202 is to perform initialization, such as, setting an initial value for the z-axis threshold and initial values for reasonable range of stride length. The reasonable range of the stride length can be, for example, between 0.5-0.9 m. Step 203 is to determine the posture of the user holding or placing the mobile device based on the initialized sensed signal, wherein the postures may include, but not restricted to, holding the mobile device in front of the chest when walking, hanging the mobile device around the waist when walking, holding the mobile device in hand and swinging naturally when walking, and so on. Step 204 is to perform step computation based on the initialized sensed signal to accomplish the estimation of the number of the steps and the step frequency. Step 205 is to obtain the map feature information and obtain the motion distance based on map information of the interior layout, corridor and turns, and sensed signal. Step 206 is to determine whether the stride length computed in step 204 is reasonable. When the stride length is reasonable, step 207 is executed to substitute the stride length and step frequency information into a stride length regression equation; and when the stride length is not reasonable, step 208 is executed to adjust the step-computing threshold dynamically and execute step 204, i.e., perform step computation.

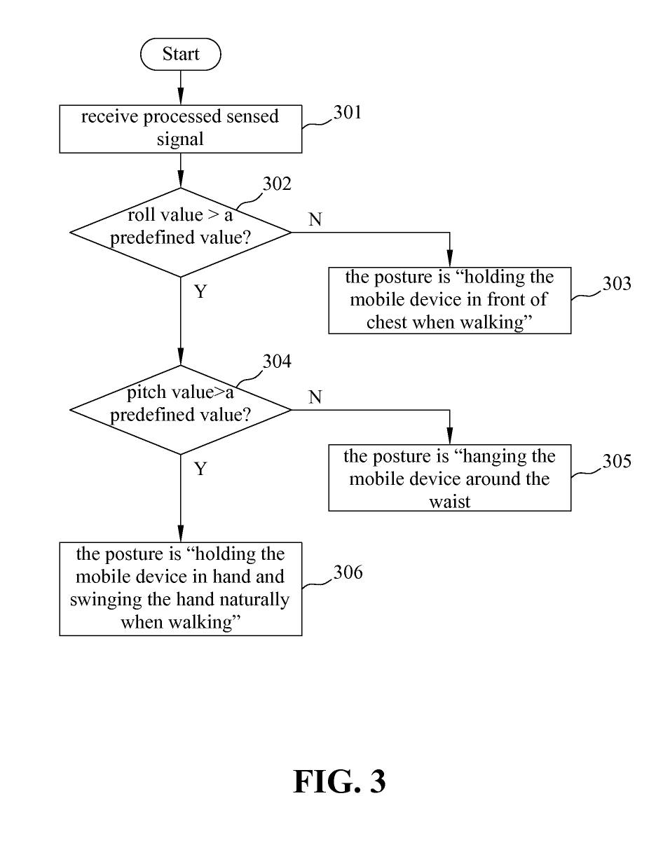

FIG. 3 shows a flowchart of the posture determination method of the multi-posture determination unit 130 according to the present disclosure. Step 301 is to received signal processed by the signal preprocessing unit 120. Step 302 is to determine whether the roll value in the processed signal is greater than a predefined value, such as, 45°. When the roll value is smaller than 45°, the posture is determined to be holding the mobile device in front of chest when walking, as shown in step 303; otherwise, step 304 is executed to determine whether the pitch value in the processed signal is greater than a predefined value, such as, 20°. When the pitch value is less than 20°, the posture is determined to be hanging the mobile device around the waist, as shown in step 305; otherwise, the posture is determined to be holding the mobile device in hand and swinging the hand naturally when walking, as shown in step 306.

In the present embodiment, the predefined roll value is 45° because the roll value will reach near 90° (or −90°) when the user holds the mobile device in hand and swings the hand naturally when walking, or when the user hangs the mobile device around the waist when walking. Therefore, the half of 90° (i.e., 45°) is selected as the predefined roll value. However, it should be understood that the choice is only illustrative, instead of restrictive. Similarly, the predefined pitch value is defined to be 20° because that pitch is between 20° and −20° when the user swings the hand naturally when walking (i.e., the range of swing is between 20° and −20°. It should be understood that the choices of the predefined roll value and the predefined pitch value can be changed by the user.

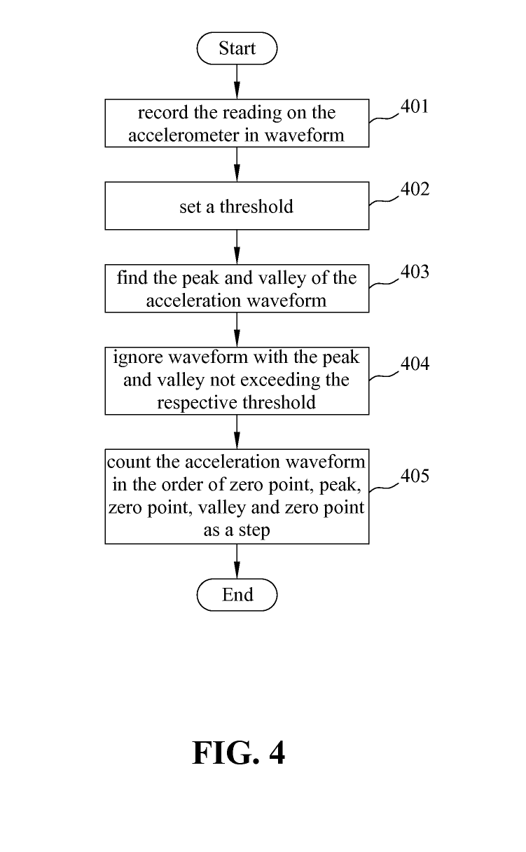

FIG. 4 shows a flowchart of a step-computing embodiment of the step-computing decision unit 140 according to the present disclosure, with z-axis acceleration as example. In step 401, the reading on the accelerometer is recorded in a format of waveform. Step 402 is to set a threshold of the acceleration waveform. The threshold is for determining whether the acceleration waveform is sufficiently prominent to meet the condition of step computation. Step 403 is to find the peak (maximum) and valley (minimum) of the acceleration waveform. In step 404, when both the peak and the valley exceed the respective threshold, the acceleration waveform is sufficiently prominent of the step computation. The waveform with the peak and valley not exceeding the respective threshold is ignored. In step 405, when the acceleration waveform is in the order of zero point, peak, zero point, valley and zero point, a complete waveform is found, and is computed as a step.

Accordingly, the step-computing decision unit 140 can compute the number of steps. With a known distance, the step frequency of the user can be computed. Then, the number of steps, the step frequency and the posture determined by the multi-posture determination unit 130 are transmitted to the map feature calibration unit 150 to determine whether the number of steps and the step frequency are reasonable by determining whether the stride length is reasonable. When the map feature calibration unit 150 determines the stride length is not seasonable, the step-computing threshold adjustment unit 160 must adjust the step-computing threshold.

In the above step-computing flow, the step-computing threshold is used to determine whether an acceleration waveform along z-axis can be counted as a step. When the threshold is too high, the steps with low z-axis acceleration (i.e., light steps) is easily overlooked. On the other hand, when the threshold is too low, a sway of the hand can be erroneously counted as a step. Because different users may demonstrate different characteristics, such as, lightness, speed, and so on, in walking, the step-computing threshold must be dynamically adjusted to obtain an accurate step count. In addition, a reasonable stride length can be estimated using known distance provided by the map feature calibration information. For example, a normal stride length for an average person is 0.5-0.9 m. When the number of steps is too few (i.e., the stride length too large), the threshold must be lowered. On the other hand, when the number of steps is too many (i.e., the stride length too small), the threshold must be raised.

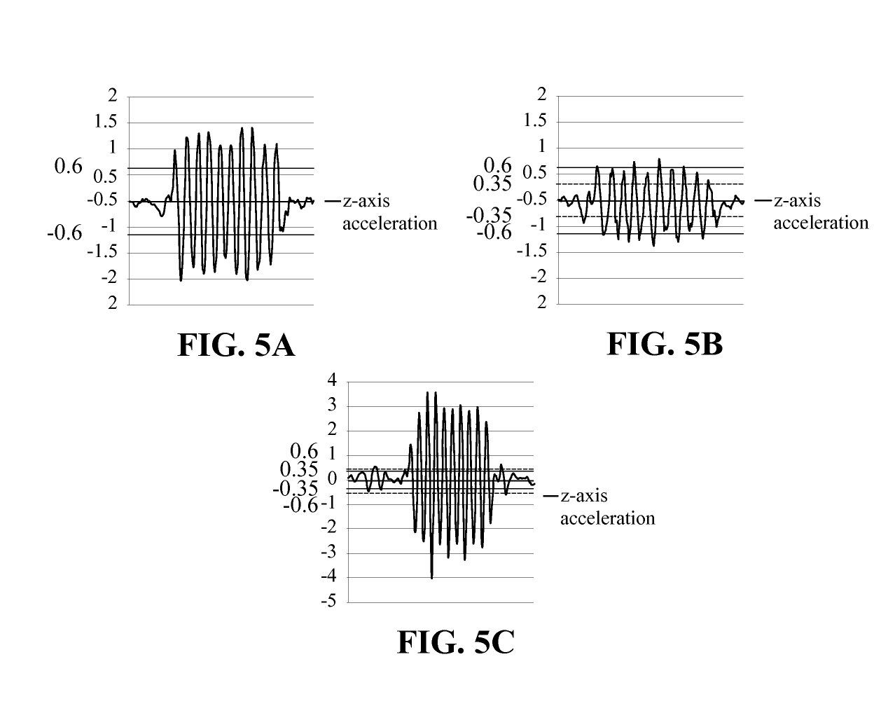

FIG. 5 shows an exemplar of adjusting step-computing threshold. When the user actually walks 10 steps in 6.5 m and the z-axis threshold is set as 0.6 and −0.6, the step-computing process can accurately estimate 10 steps, with the average of each step as 0.65 m, which is within the reasonable range, as shown in FIG. 5A. However, as shown in FIG. 5B, when the user has a light step, which indicates a relatively smaller amplitude of z-axis acceleration, only four steps can be counted when using 0.6 and −0.6 as the z-axis threshold, which means that the stride length is 1.625 m, not within the reasonable range. Therefore, the z-axis threshold must be lowered, for example, to 0.35 and −0.35. With the adjusted z0axis threshold, 10 steps can be counted. On the other hand, as shown in FIG. 5C, when the user holds in the mobile phone in hand, the light swaying of hand may be mistakenly counted as a step. In such a scenario, with the z-axis threshold at 0.35 and −0.35 and the user walking 10 steps in and swaying hand, 14 steps are counted, which means that the stride length is 0.462, not within the reasonable range. Therefore, the z-axis threshold must be adjusted to 0.6 and −0.6 to obtain the estimate of 10 steps. As such, the dynamic adjustment of the z-axis threshold can assist to obtain the accurate step-computing to accommodate various step styles and lightness.

The algorithm to estimate the stride length allows stride lengths of the user in a stable walking state to vary according to height, weight, age, frequency, speed, and so on. The stride length affects the precision of indoor positioning. The known technique often uses height, weight, leg length and age as input parameter to construct a stride length regression mapping model. However, the user must input personal data as variables to the stride length regression mapping model and further data collection must be conducted to establish a large database to improve the accuracy of stride length estimation. Therefore, the present disclosure provides a real-time dynamic stride length calibration method to further improve the stride length estimation accuracy.

In general, the step frequency and the stride length are related, that is, the higher the frequency, the larger the stride length; and the lower the frequency, the smaller the stride length will be. A stride length regression mapping model can be constructed according to the relation between the step frequency and the stride length. However, the known technique is to apply the same stride length regression equation to all the users, which leads to erroneous stride length estimation. The flow of computation is as follows:

Stride length(SL)=distance(L)/number of steps (1)

Average step interval(SI)=ΣΔt/number of steps (2)
Where Δt is the time for each step

Step frequency(SF)=1/SI (3)

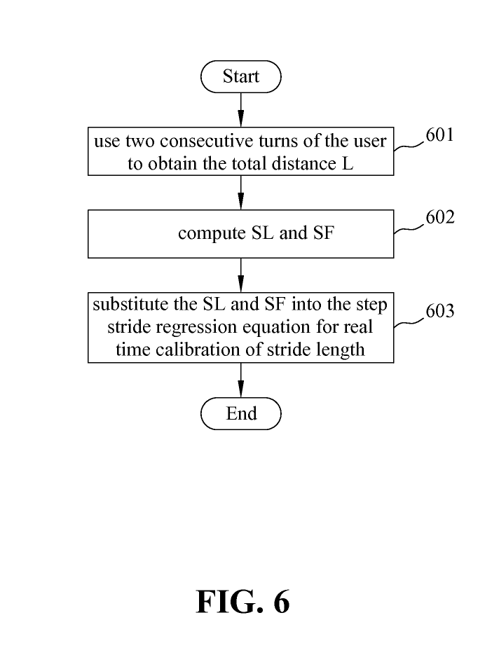

FIG. 6 shows a flowchart of the real-time dynamic stride length calibration method of the present disclosure. As shown in FIG. 6, step 601 is to obtain information on each distance (length) of passage and corridor from the indoor map information, and using two consecutive turns of the user to obtain the total distance L of the passed passages, wherein the total distance L also able to be obtained through related positioning technique, such as, global positioning system (GPS), infrared, ultrasound, radio frequency identification (RFID), ultra wideband, visible light communication, Bluetooth, Zigbee, image positioning, WiFi and IMUs. In step 602, the SL and SF can be obtained through the total number of steps and the time of passing the passage recorded by inertial measurement unit, and SL and SF not within the reasonable range are filtered. In step 603, after obtaining SL and SF, the SL and SF are substituted into the step stride regression equation to obtain the linear relation between SL and SF:

SLᵢ=α×SFᵢ+β (4)

Where SLᵢ and SFᵢ are the i-th SL and Sf respectively;
α is the slope of the linear relation between Sl and SF, and
β is a constant.

The advantage of the above dynamic stride length calibration method is that in the stride length regression mapping model, each user can have a particular real-time calibration stride length and correction regression equation for different posture, and the user is not required to input any parameters for the stride length regression mapping model, which is more convenient. It should be noted that the stride length regression computation includes linear regression and non-linear regression methods.

For example, through the indoor map information, the user can obtain a total distance L. With the inertial measurement unit to estimate the SL and SF of the user, the relation between SF and SL can be computed for different walking speed: such as, when the user uses the posture of holding the mobile device in front of the chest when walking, the user walks at a normal speed, a fast speed and a slow speed, respectively. With the relation between SL and SF at different speeds, the SL regression curve or line for the posture of holding the mobile device in front of the chest when walking can be obtained. Similarly, when the user adopts the posture of hanging the mobile device around the waist when walking, or the posture of holding the mobile device in hand and swaying the hang, corresponding SL regression curve or line can also be obtained.

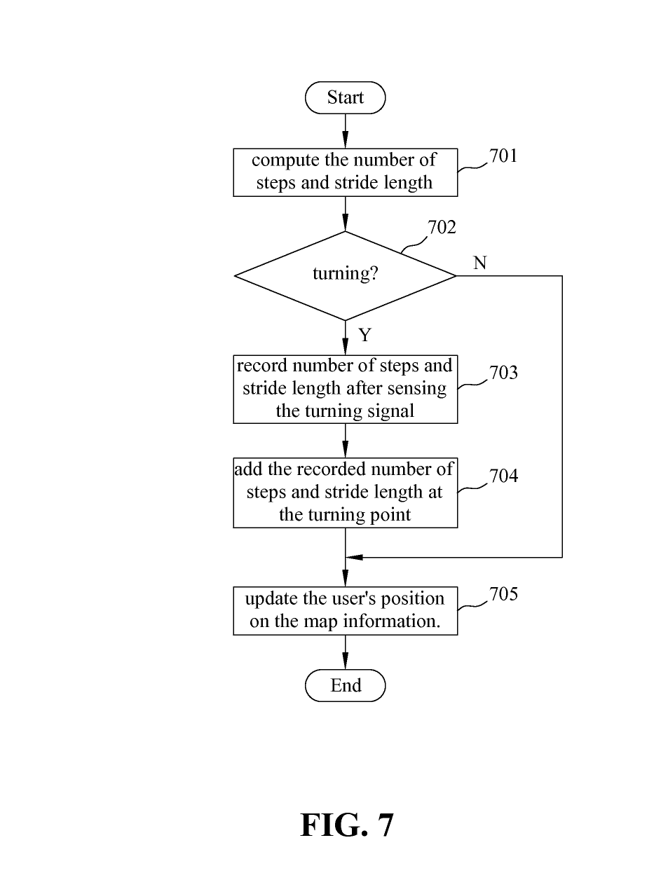

When the user moves in indoor space for an extended period of time, the positioning error also accumulates as the movement distance increases. The present disclosure calibrates the user positioning by map feature calibration and the inertial measurement unit indoor positioning. FIG. 7 shows a flowchart of using map feature and turning signal sensed by inertial measurement unit in indoor positioning according to the present disclosure. Step 701 is to use signal sensed by the inertial measurement unit 110 to compute the number of steps and stride length. Step 702 is to determine whether a turning signal is sensed. When no turning signal is sensed by the gyroscope or the magnetometer (i.e., walking straight ahead), the process executes step 705 to update the user's position on the map information; otherwise, step 703 is executed to record number of steps and stride length after sensing the turning signal and followed by step 704 to add the recorded number of steps and stride length at the turning point and step 705 to update the user's position on the map information.

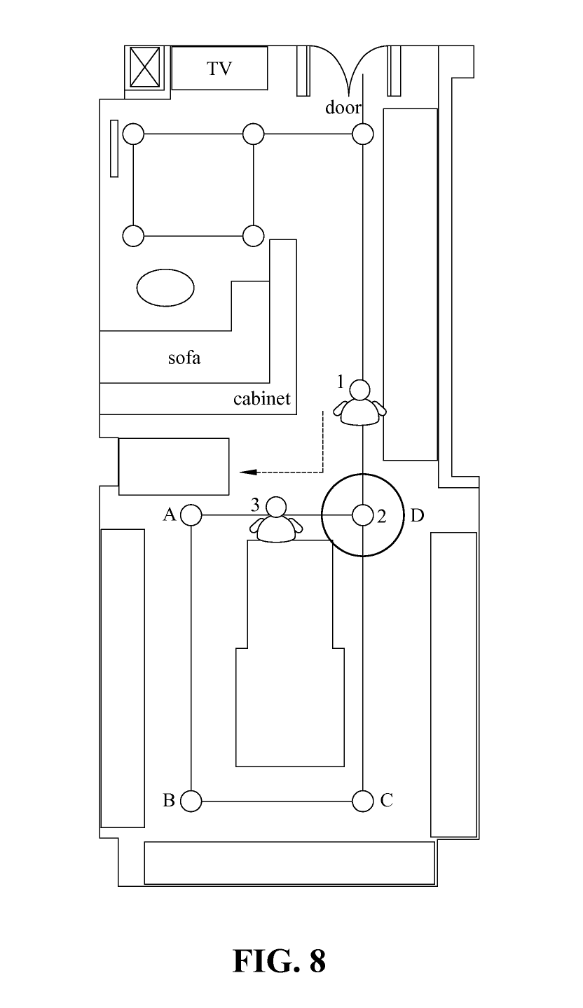

FIG. 8 shows an exemplar of using map feature and turning signal to calibrate indoor positioning in FIG. 7, wherein label 1 is the current position of the user shown in the map information; label 2 is the position where a turning signal is sensed by the gyroscope and the magnetometer but the map information not yet shows the user at label 2; and label 3 is for the map information to place the user at the point of turning, add the recorded post-turning number of steps and stride length and update the user to the current position (i.e., label 3).

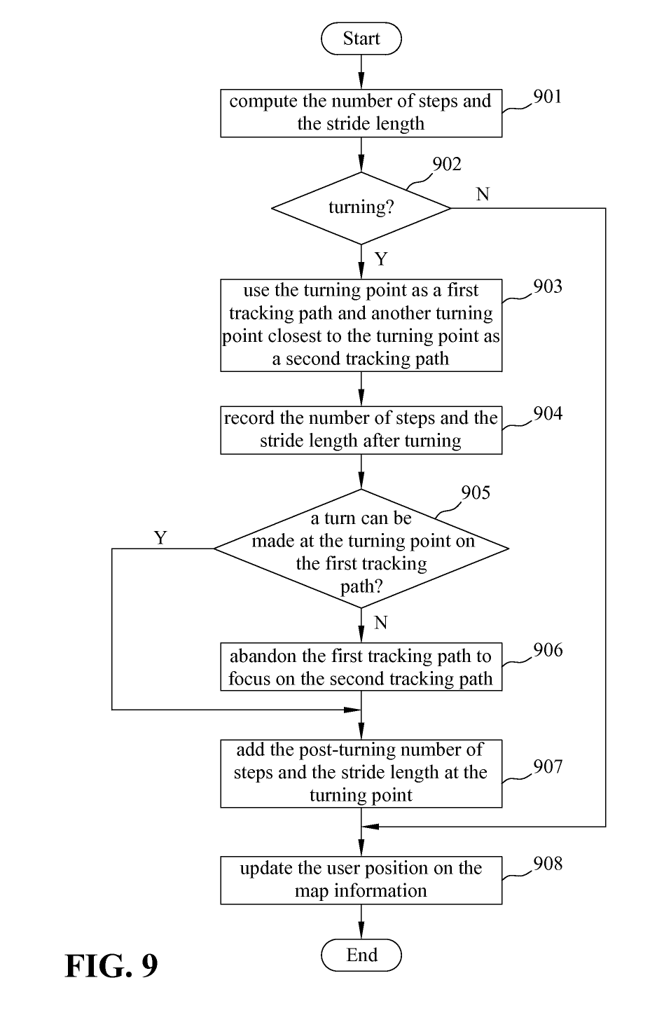

FIG. 9 shows a flowchart of using map feature and multi-path tracking to calibrate indoor positioning according to the present disclosure. Step 901 is for the inertial measurement unit 110 to compute the number of steps and the stride length. Step 902 is to determine whether a turning signal is sensed. When no turning signal is sensed by the gyroscope or the magnetometer (i.e., walking straight ahead), step 908 is executed to update the user position on the map information; otherwise, step 903 is executed to use the turning point as a first tracking path and another turning point closest to the turning point as a second tracking path. Step 904 is to record the number of steps and the stride length after turning. Step 905 is to determine whether a turn can be made at the turning point on the first tracking path, i.e., to determine the turning feature. If a turn can be made at the turning point on the first tracking path, step 907 is executed to add the post-turning number of steps and the stride length at the turning point, followed by step 908 to update the user position on the map information; otherwise, step 906 is executed to abandon the first tracking path to focus on the second tracking path, followed by step 907 to add the post-turning number of steps and the stride length at the turning point, and step 908 to update the user position on the map information.

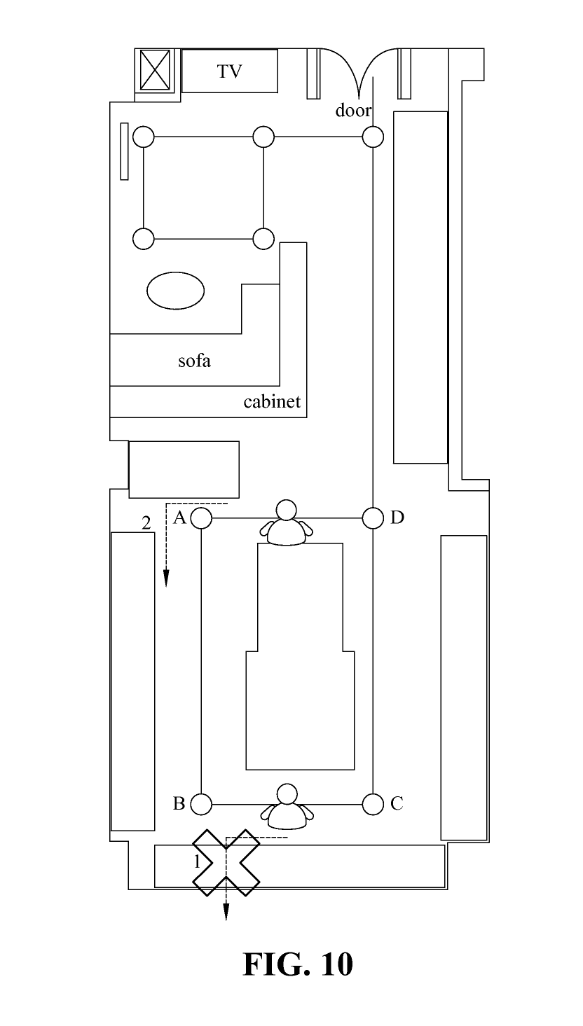

FIG. 10 shows an exemplary of using map feature and multi-path tracking to calibrate indoor positioning in FIG. 9. As shown in FIG. 10, at the current position shown in FIG. 8 (label 3), assuming that label 1 is the position where the gyroscope and magnetometer sensing a downward turning signal occurring and allowing the user to continue moving, the first tracking path shows impossible to turn downwards and continue moving according to the map feature and yet the second tracking path allows turning downwards and continuing moving. Therefore, the first tracking path is an incorrect tracking path and the second tracking path (label 2) is the correct tracking path. The turning information and the post-turning number of steps and the stride length are recorded, followed by the map information placing the user to the turning point of the second tracking path (label 3 in FIG. 8). And adding the recorded number of steps and stride length and updating the current position.

The multi-posture stride length calibration system for indoor positioning can be also realized with a server/client architecture, as aforementioned. For example, the inertial measurement unit 110, the signal preprocessing unit 120, the multi-posture determination unit 130 and the step-computing decision unit 140 are disposed on a terminal mobile device; the map feature calibration unit 150, the step-computing threshold adjustment unit 160 and the stride length regression unit 170 are disposed on a server; and a signal receiving and transmitting device (not shown) is disposed on the terminal mobile device and the server respectively for receiving and transmitting signal. When the step-computing decision unit 140 finishes counting the number of steps, the step-computing decision unit 140 transmits the information of the number of steps, step frequency and posture to the server through the signal receiving and transmitting device on the terminal mobile device. On the other hand, when the signal receiving and transmitting device on the mobile device receives signal to update step-computing threshold, the step-computing threshold decision unit 140 will re-compute the steps and then transmits the information of the number of steps, step frequency and posture to the server through the signal receiving and transmitting device on the terminal mobile device (i.e., repeating the above process). Correspondingly, at the server, the signal receiving and transmitting device receives the information of the number of steps, step frequency and posture from the signal receiving and transmitting device on the terminal mobile device, and the map feature calibration unit 150 determines whether the stride length is within the reasonable range. If not, the step-computing threshold adjustment unit 160 adjusts the threshold and transmits to the mobile device through the signal receiving and transmitting device. If the stride length is within reasonable range, the relation step frequency and the stride length is substituted into the stride length regression unit 170 to update the stride length regression curve of the posture.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A multi-posture stride length calibration system for indoor positioning, comprising:
at least an inertial measurement unit, configured to sense at least a signal of a mobile device; and
a multi-posture determination unit, configured to receive the sensed signal and determine at least a posture of the mobile device based on the signal.

2. The multi-posture stride length calibration system for indoor positioning as claimed in claim 1, wherein the sensed signal used in determining the posture comprises readings of a magnetometer.

3. The multi-posture stride length calibration system for indoor positioning as claimed in claim 1, further comprising a signal preprocessing unit, connected to the inertial measurement unit to process the sensed at least a signal.

4. The multi-posture stride length calibration system for indoor positioning as claimed in claim 3, wherein the processed sensed signal used in determining the posture further comprises any combination of a roll, a pitch and a yaw of an accelerometer, a gyroscope or a magnetometer.

5. The multi-posture stride length calibration system for indoor positioning as claimed in claim 1, further comprising a step-computing decision unit, configured to compute a number of steps and a step frequency based on the processed sensed signal.

6. The multi-posture stride length calibration system for indoor positioning as claimed in claim 5, wherein the step-computing decision unit computes a step frequency of each step based on the processed sensed signal.

7. The multi-posture stride length calibration system for indoor positioning as claimed in claim 1, further comprising:
wherein a map feature calibration unit, configured to receive the number of steps, step frequency and posture to determined whether a stride length matching a criterion;
a step-computing threshold adjustment unit, configured to adjust a step-computing threshold when the stride length not matching the criterion; and
a stride length regression unit, configured to update a stride length regression curve for posture based on step frequency and stride length when the stride length matching the criterion.

8. The multi-posture stride length calibration system for indoor positioning as claimed in claim 1, wherein the inertial measurement unit is one of an accelerometer, a gyroscope or a magnetometer.

9. The multi-posture stride length calibration system for indoor positioning as claimed in claim 7, wherein adjusting the step-computing threshold is determined according to an amplitude of the sensed signal in a direction.

10. The multi-posture stride length calibration system for indoor positioning as claimed in claim 7, wherein the step-computing threshold is adjusted to a smaller value when the stride length is larger than the criterion and adjusted to a larger value when the stride length is smaller than the criterion.

11. The multi-posture stride length calibration system for indoor positioning as claimed in claim 7, wherein the stride length regression curve is obtained by a stride length regression computation.

12. The multi-posture stride length calibration system for indoor positioning as claimed in claim 11, wherein the stride length regression computation is one of a linear regression method and a non-linear regression method.

13. The multi-posture stride length calibration system for indoor positioning as claimed in claim 7, wherein the map feature calibration unit further comprises a turning signal map calibration and a multi-path tracking map calibration.

14. The multi-posture stride length calibration system for indoor positioning as claimed in claim 13, wherein the turning signal map calibration is determined according to two consecutive turning signals of the processed sensed signal and a movement distance.

15. The multi-posture stride length calibration system for indoor positioning as claimed in claim 14, wherein the movement distance is obtained by one of the following positioning techniques: global positioning system (GPS), infrared, ultrasound, radio frequency identification (RFID), ultra wideband, visible light communication, Bluetooth, Zigbee, image positioning, WiFi, and IMU.

16. The multi-posture stride length calibration system for indoor positioning as claimed in claim 13, wherein the multi-path tracking map calibration is determined by judging turning feature of a path.

17. A multi-posture stride length calibration system for indoor positioning, comprising a mobile device and a server, wherein the mobile device further comprising:
at least an inertial measurement unit, configured to sense at least a signal of the mobile device; and
a multi-posture determination unit, configured to receive the sensed signal and determine at least a posture of the mobile device based on the signal;
the server further comprising:
a signal receiving and transmission unit, configured to receive a number of steps, a step frequency and a posture; and
a map feature calibration unit, configured to receive the number of steps, step frequency and the posture to determine whether a stride length matching a criterion.

18. The multi-posture stride length calibration system for indoor positioning as claimed in claim 17, wherein the sensed signal used in determining the posture comprises readings of a magnetometer.

19. The multi-posture stride length calibration system for indoor positioning as claimed in claim 17, wherein the mobile device further comprises a signal preprocessing unit, connected to the inertial measurement unit to process the sensed at least a signal.

20. The multi-posture stride length calibration system for indoor positioning as claimed in claim 19, wherein the processed sensed signal used in determining the posture further comprises any combination of a roll, a pitch and a yaw of an accelerometer, a gyroscope or a magnetometer.

21. The multi-posture stride length calibration system for indoor positioning as claimed in claim 17, wherein the mobile device further comprises:
a step-computing decision unit, configured to compute a number of steps and a step frequency based on the processed sensed signal; and
a signal receiving and transmission unit, configured to transmit a number of steps, a step frequency and a posture; and to receive an update message.

22. The multi-posture stride length calibration system for indoor positioning as claimed in claim 17, wherein the server further comprises:
a step-computing threshold adjustment unit, configured to adjust a step-computing threshold when the stride length not matching the criterion, and the step-computing threshold being transmitted as an update message by the signal receiving and transmission unit; and
a stride length regression unit, configured to update a stride length regression curve for posture based on step frequency and stride length when the stride length matching the criterion.

23. The multi-posture stride length calibration system for indoor positioning as claimed in claim 17, wherein the inertial measurement unit is one of an accelerometer, a gyroscope or a magnetometer.

24. The multi-posture stride length calibration system for indoor positioning as claimed in claim 22, wherein adjusting the step-computing threshold is determined according to an amplitude of the sensed signal in a direction.

25. The multi-posture stride length calibration system for indoor positioning as claimed in claim 22, wherein the step-computing threshold is adjusted to a smaller value when the stride length is larger than the criterion and adjusted to a larger value when the stride length is smaller than the criterion.

26. The multi-posture stride length calibration system for indoor positioning as claimed in claim 22, wherein the stride length regression curve is obtained by a stride length regression computation.

27. The multi-posture stride length calibration system for indoor positioning as claimed in claim 23, wherein the stride length regression computation is one of a linear regression method and a non-linear regression method.

28. The multi-posture stride length calibration system for indoor positioning as claimed in claim 22, wherein the map feature calibration unit further comprises a turning signal map calibration and a multi-path tracking map calibration.

29. The multi-posture stride length calibration system for indoor positioning as claimed in claim 28, wherein the turning signal map calibration is determined according to two consecutive turning signals of the processed sensed signal and a movement distance.

30. The multi-posture stride length calibration system for indoor positioning as claimed in claim 29, wherein the movement distance is obtained by one of the following positioning techniques: global positioning system (GPS), infrared, ultrasound, radio frequency identification (RFID), ultra wideband, visible light communication, Bluetooth, Zigbee, image positioning, WiFi, and IMU.

31. The multi-posture stride length calibration system for indoor positioning as claimed in claim 28, the multi-path tracking map calibration is determined by judging turning feature of a path.

32. A multi-posture stride length calibration method for indoor positioning, comprising the following steps:
obtaining at least a sensed signal; and
based on the sensed signal, performing a posture judgment to determine a posture.

33. The multi-posture stride length calibration method for indoor positioning as claimed in claim 32, wherein the sensed signal used in determining the posture comprises readings of a magnetometer.

34. The multi-posture stride length calibration method for indoor positioning as claimed in claim 32, wherein the sensed signal is processed before used in determining the posture.

35. The multi-posture stride length calibration method for indoor positioning as claimed in claim 34, wherein the processed sensed signal used in determining the posture further comprises any combination of a roll, a pitch and a yaw of an accelerometer, a gyroscope or a magnetometer.

36. The multi-posture stride length calibration method for indoor positioning as claimed in claim 32, further comprising the following step:
based on the processed sensed signal, performing a step computation to compute a number of steps.

37. The multi-posture stride length calibration method for indoor positioning as claimed in claim 36, further comprising the following step:
based on the processed sensed signal, computing a step frequency of each step.

38. The multi-posture stride length calibration method for indoor positioning as claimed in claim 32, further comprising the following steps:
based on the number of steps, step frequency and posture, computing a stride length and determining whether the stride length matching a criterion; when the stride length matching the criterion, updating a stride length regression curve for posture based on step frequency and stride length; and when the stride length not matching the criterion, adjusting a step-computing threshold and reperforming step computation.

39. The multi-posture stride length calibration method for indoor positioning as claimed in claim 32, further comprising the following step:
obtaining map feature information.

40. The multi-posture stride length calibration method for indoor positioning as claimed in claim 38, wherein adjusting the step-computing threshold is determined according to an amplitude of the sensed signal in a direction.

41. The multi-posture stride length calibration method for indoor positioning as claimed in claim 38, wherein the step-computing threshold is adjusted to a smaller value when the stride length is larger than the criterion and adjusted to a larger value when the stride length is smaller than the criterion.

42. The multi-posture stride length calibration method for indoor positioning as claimed in claim 38, wherein the stride length regression curve is obtained by a stride length regression computation.

43. The multi-posture stride length calibration method for indoor positioning as claimed in claim 42, wherein the stride length regression computation is one of a linear regression method and a non-linear regression method.

44. The multi-posture stride length calibration method for indoor positioning as claimed in claim 38, further comprising a step of map feature calibration, wherein the map feature calibration step comprising: a turning signal map calibration step and a multi-path tracking map calibration step.

45. The multi-posture stride length calibration method for indoor positioning as claimed in claim 44, wherein the turning signal map calibration step is to calibrate the turning signal map information according to two consecutive turning signals of the processed sensed signal and a movement distance.

46. The multi-posture stride length calibration method for indoor positioning as claimed in claim 45, wherein the movement distance is obtained by one of the following positioning techniques: global positioning system (GPS), infrared, ultrasound, radio frequency identification (RFID), ultra wideband, visible light communication, Bluetooth, Zigbee, image positioning, WiFi, and IMU.

47. The multi-posture stride length calibration method for indoor positioning as claimed in claim 36, wherein the multi-path tracking map calibration step is to calibrate map information by judging turning feature of a path.

48. A multi-posture stride length calibration method for indoor positioning, applicable to a mobile device and a server, wherein the mobile device executing the following steps:
obtaining at least a sensed signal; and
based on the sensed signal, performing a posture judgment to determine a posture;
the server executing the following steps:
receiving a number of steps, a step frequency and a posture; and
based on the number of steps, step frequency and posture, computing a stride length and determining whether the stride length matching a criterion;

49. The multi-posture stride length calibration method for indoor positioning as claimed in claim 48, wherein the sensed signal used in determining the posture comprises readings of a magnetometer.

50. The multi-posture stride length calibration method for indoor positioning as claimed in claim 48, wherein the sensed signal is processed before used in determining the posture.

51. The multi-posture stride length calibration method for indoor positioning as claimed in claim 50, wherein the processed sensed signal used in determining the posture further comprises any combination of a roll, a pitch and a yaw of an accelerometer, a gyroscope or a magnetometer.

52. The multi-posture stride length calibration method for indoor positioning as claimed in claim 48, wherein the mobile device further comprising the following step:
based on the processed sensed signal, performing a step computation to compute a number of steps and a step frequency for each step;
transmitting the number of steps, the step frequency and the posture, and receiving an update message.

53. The multi-posture stride length calibration method for indoor positioning as claimed in claim 48, the server further comprising the following steps:
when the stride length matching the criterion, updating a stride length regression curve for posture based on step frequency and stride length; and when the stride length not matching the criterion, adjusting a step-computing threshold and reperforming step computation.

54. The multi-posture stride length calibration method for indoor positioning as claimed in claim 48, further comprising the following step:
obtaining map feature information.

55. The multi-posture stride length calibration method for indoor positioning as claimed in claim 53, wherein adjusting the step-computing threshold is determined according to an amplitude of the sensed signal in a direction.

56. The multi-posture stride length calibration method for indoor positioning as claimed in claim 53, wherein the step-computing threshold is adjusted to a smaller value when the stride length is larger than the criterion and adjusted to a larger value when the stride length is smaller than the criterion.

57. The multi-posture stride length calibration method for indoor positioning as claimed in claim 53, wherein the stride length regression curve is obtained by a stride length regression computation.

58. The multi-posture stride length calibration method for indoor positioning as claimed in claim 57, wherein the stride length regression computation is one of a linear regression method and a non-linear regression method.

59. The multi-posture stride length calibration method for indoor positioning as claimed in claim 53, further comprising a step of map feature calibration, wherein the map feature calibration step comprising: a turning signal map calibration step and a multi-path tracking map calibration step.

60. The multi-posture stride length calibration method for indoor positioning as claimed in claim 59, wherein the turning signal map calibration step is to calibrate the turning signal map information according to two consecutive turning signals of the processed sensed signal and a movement distance.

61. The multi-posture stride length calibration method for indoor positioning as claimed in claim 60, wherein the movement distance is obtained by one of the following positioning techniques: global positioning system (GPS), infrared, ultrasound, radio frequency identification (RFID), ultra wideband, visible light communication, Bluetooth, Zigbee, image positioning, WiFi, and IMU.

62. The multi-posture stride length calibration method for indoor positioning as claimed in claim 59, wherein the multi-path tracking map calibration step is to calibrate map information by judging turning feature of a path.
